(19) United States
(12) Patent Application Publication
(10) Pub. No.: US 2011/0251935 A1
(43) Pub. Date: Oct. 13, 2011

(54) Mobile Battery Replacement Unit

(76) Inventors: Guy German, Kibbutz Magal (IL); Yossi German, Kibbutz Magal (IL)

(21) Appl. No.: 13/139,452

(22) PCT Filed: Dec. 15, 2009
(86) PCT No.: PCT/IL09/01191

§ 371 Date: Jun. 13, 2011

Related U.S. Application Data
(60) Provisional application No. 61/122,432, filed on Dec. 15, 2008.

(51) Int. Cl. B60S 5/06; G06Q 10/00

(52) U.S. Cl. 705/30; 700/218; 700/213; 414/809

(57) ABSTRACT

This present invention provides a method for portable electric vehicle battery replacement comprised of providing a platform adapted for holding an electric vehicle upon it, storing a plurality of electric vehicle batteries, and loading charged batteries into the electric vehicles.

### FIELD OF THE INVENTION

The present invention relates to a method and apparatus for replacement of batteries in battery-powered electric vehicles.

### BACKGROUND OF THE INVENTION

The present invention is in the technical field of recharge solutions for Battery Electrical Vehicles. In particular, the present invention is in the technical field of the Electrical Recharge Grid/Infrastructure for battery electrical vehicles.

The widespread use of electric vehicles stands to reduce pollutant emissions and dependence upon fossil fuels. The motoring infrastructure will have to undergo some modifications before this is a practical possibility, requiring most obviously a battery replacement infrastructure, for those cases where the battery electric vehicle (BEV) driver wants to exceed the range of a single battery. Replacement instead of recharge is called for, since at the current state of the art, recharge times are far longer than most drivers are willing to wait. In addition to the need for a network of battery replacement stations, there will arise the problem of drivers stranded due either to battery malfunction or simple depletion of battery energy, the BEV equivalent of being stranded without gas. The current application purports to aid in both of these infrastructure challenges.

Chinese application 11214814A, provides “a parallel mobile platform, a rotating platform, a track, a vertical lifting device and a battery tray. The parallel mobile platform is positioned on the track and moves along the track. The rotating platform is positioned on the parallel mobile platform. The battery tray is positioned on the rotating platform via the vertical lifting device. The battery tray is equipped with an electromagnetic suction device for drawing the battery box”. Due to the use of a track upon which the mobile platform travels, the device is suited for a stationary battery exchange station rather than a mobile or deployable battery replacement unit. Furthermore the device relies upon a complex electromagnetic suction device for drawing the battery box into the battery tray. Additionally there is no provision for providing a standalone battery replacement unit that can be placed in the field and used by electric vehicles to swap batteries.

Several patents found in the prior art relate to battery operated vehicles or equipment in mines, for which portable replacement systems have been developed such as U.S. Pat. No. 5,399,061. In this patent, “a battery holder for containing an electric storage battery is transported by a lift unit on a mobile vehicle. The lift unit is pivotally mounted at a rearward end portion of the vehicle to move into surrounding relation with the battery holder positioned on the ground. The lift unit is pivoted upwardly to raise the battery holder to a preselected elevation within the minimal lateral and overhead clearance available in an underground mine. The lift unit includes a pair of lifting forks extending in spaced parallel relation from the vehicle within the lateral dimensions of the vehicle. The lifting forks have a configuration adapted to permit downward movement of the forks into engagement with the ground to pick up a battery holder positioned on the ground. The lifting forks extend laterally of the battery holder and engage the holder for vertical movement to an elevated position that does not exceed the uppermost position for transportation of the battery in areas of minimal overhead clearance.” While providing for a mobile unit that can pick, lift and transport a battery, there is no provision for the complete operation of removing and replacing a battery such as would be needed in a battery electric vehicle replacement unit. Furthermore there is no provision for providing a standalone portable battery replacement unit that can be placed in the field and used by electric vehicles to swap batteries in automated fashion. Similarly, Japanese patent application 2005096503 provides a portable trolley or carriage for battery replacement. The method consists of “positioning the carriage to an electric vehicle, and easily connecting the carriage and an electric vehicle by operating a locking tool while moving the carriage at the time of replacing the battery.” However it is clear that this hand-operated wagon is not itself propelled by independent motoring means, thus limiting its use to a small area such as the environs of a car garage. The device is clearly not capable of traveling tens of kilometers into the field to replace the battery of a stranded vehicle, nor is it capable of carrying out the replacement process in an automated fashion since its placement into proximity with the electric vehicle is manual. It also clearly cannot be used as a standalone battery replacement unit that can be placed in the field and used by electric vehicles to swap batteries in automated fashion.

There thus remains a long-felt need for a device capable of traveling or being transported into the field to replace the battery of a stranded vehicle, capable of the replacement process in an automated fashion, as well as serving as a standalone battery replacement unit that can be left in the field and used by electric vehicles to swap batteries in automated fashion, increasing the range of electric vehicle travel.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which;

FIGS. 1A-L presents a possible embodiment of a battery exchange unit.

FIG. 1M presents a trailer from the prior art.

FIGS. 2A-C presents a possible embodiment of a battery receiving/replacement unit.

FIG. 3 presents a side view of a car on a battery exchange unit on a truck.

FIGS. 4A-B presents side views of an embodiment of a battery exchange unit with foldable ramp.

FIGS. 5A-D presents a tire centering mechanism.

FIG. 6 presents another embodiment of a battery exchange unit.

FIGS. 7A-K presents a battery exchange unit as deployed from a truck.

### SUMMARY OF THE INVENTION

A portable device (carried on a trailer, towed e.g. by a truck, or placed at an arbitrary location) is provided that allows removal and replacement of an electric vehicle battery of ˜250 kg. The device consists of a flat platform provided with a lift and battery removal and replacement means. The trailer's ramp (or truck's ramp) allows the vehicle to drive or be towed or pushed onto the flat platform. The vehicle lift, which may be for instance a four pillar lift, raises the vehicle up to a height of ˜1 meter off the platform, allowing access to the underside of the vehicle. A receiving unit is provided that travels on rails on the platform, and is lifted by a battery lift (which may be a scissor lift for instance) when under the vehicle battery bay, until such point as the receiving unit engages the battery. The battery is then disengaged from the vehicle and is lowered by the receiving unit, which then moves from under the vehicle battery bay. A replacement unit is also provided that carries a charged battery and that now moves under the vehicle battery bay. The battery lift then inserts the replacement battery into the vehicle. The vehicle then engages the battery. The receiving and replacement units now travel out from under the vehicle, the vehicle is lowered from its lift, and the vehicle may then be driven off the platform.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a mobile battery replacement unit.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘vehicle’ refers hereinafter to any device adapted for transport, such as a car, truck, tractor, trailer, semi-trailer, wheeled cart, and the like.

The term ‘BEV’ refers to a battery electric vehicle, namely a vehicle that operates largely or entirely on electric power stored in batteries.

The term ‘BE’ refers to battery exchange.

The term ‘BEU’ refers to the battery exchange unit of the instant invention, namely a portable device adapted for replacing the battery of a BEV.

The term ‘BRRU’ refers to the battery receiving/replacement unit of the instant invention, namely a portable device adapted for being loaded with a depleted or fresh battery, and in some embodiments adapted to raise and lower the battery.

The term ‘plurality’ refers hereinafter to any integer number equal to or greater than 1, e.g, 2-10, especially 2-4.

The invention provides a mobile system and method for electric vehicle battery replacement. The invention is suitable for replacing the batteries of stranded cars, as well as enabling fast creation of a battery replacement grid by enabling scalable and dynamic deployment of battery exchange spots.

The device of the current invention allows implementation of a minimal but effective battery exchange station, useful for example in remote areas where a full blown station is actually not needed.

This minimal battery replacement station may either be transported by another vehicle such as carried on a truck bed or trailer, or may itself be mobile, opening new possibilities for the rapid expansion of a network of such replacement stations to increase the range of electric travel.

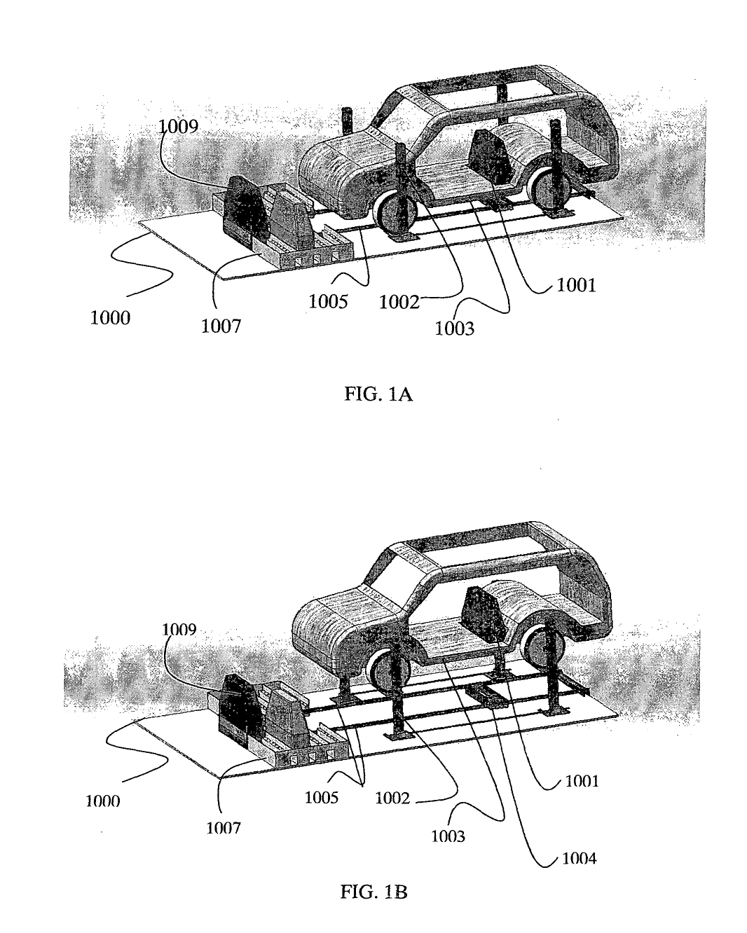

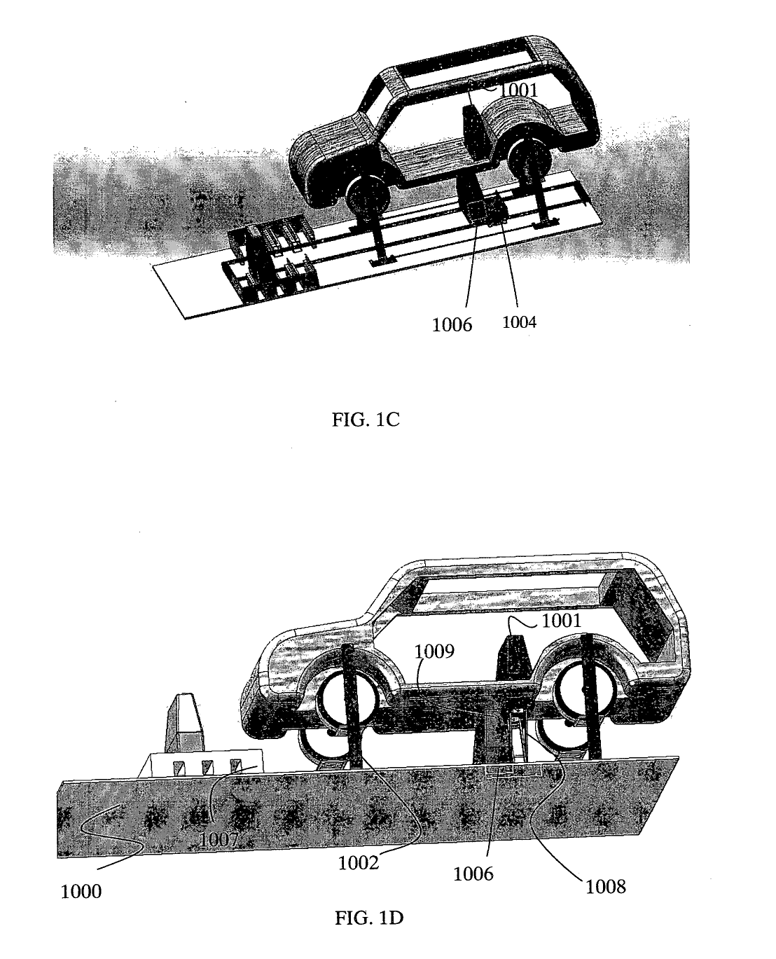

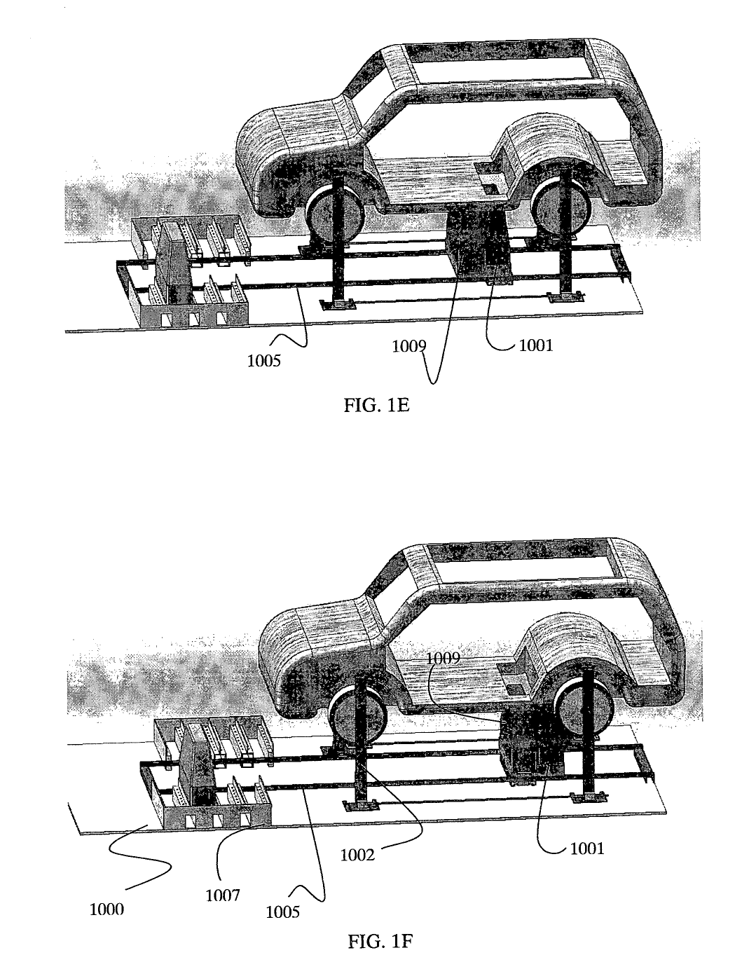

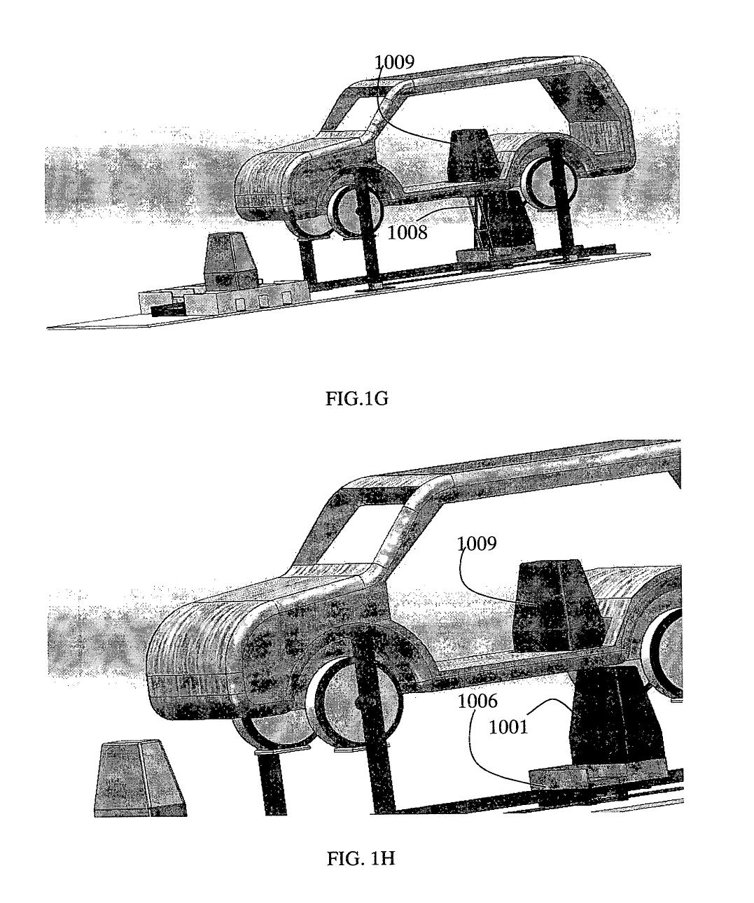

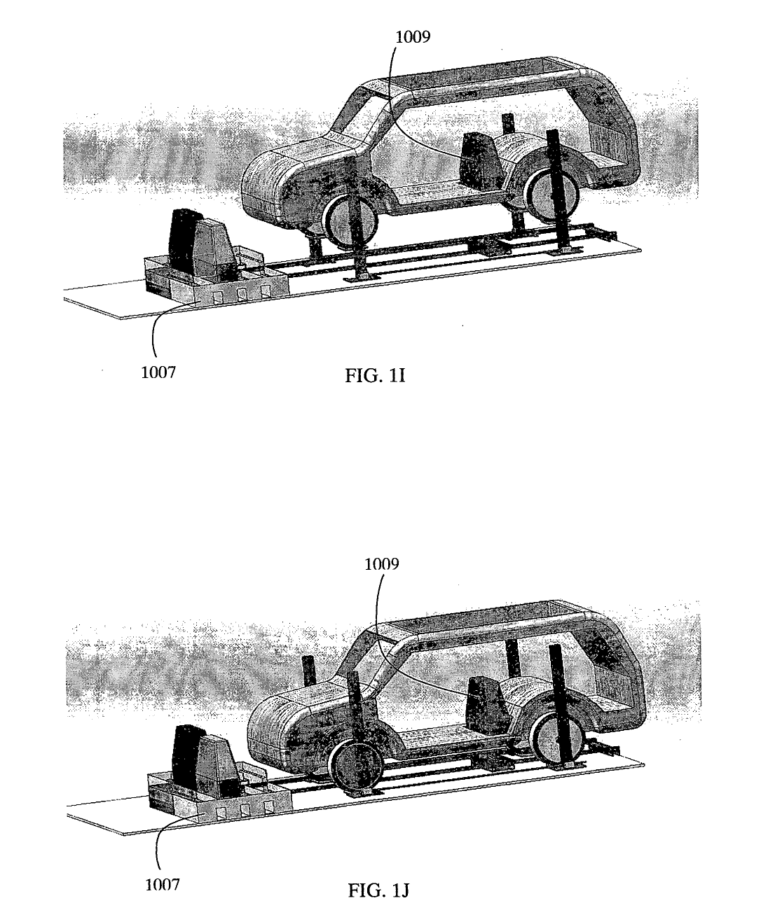

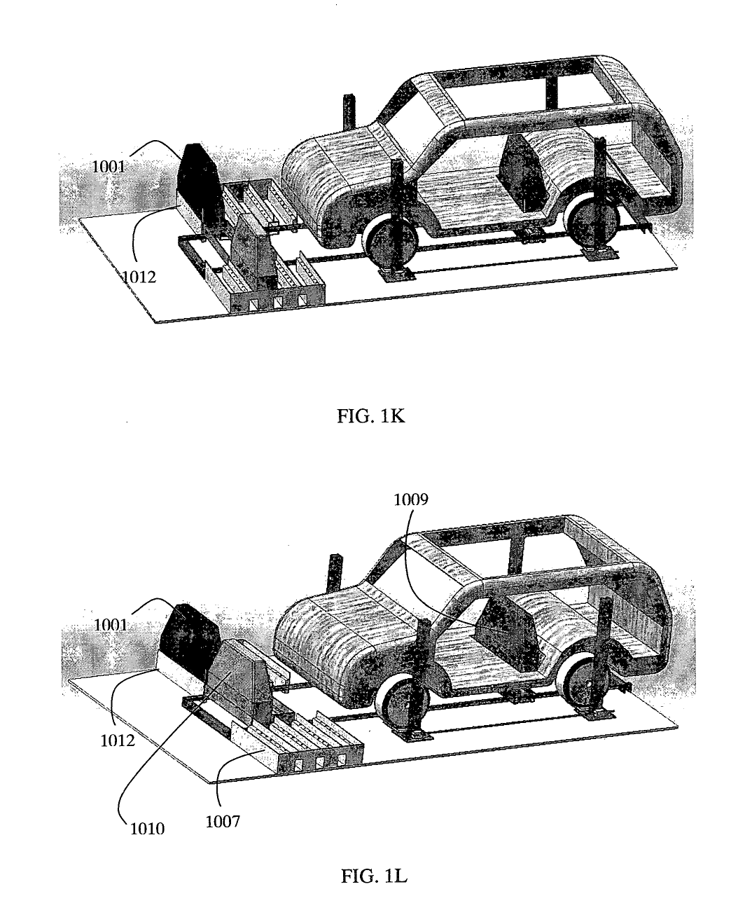

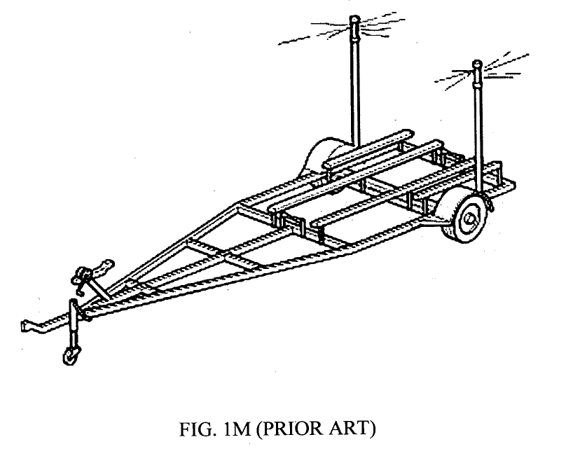

In brief the device consists of a portable flat platform provided with a vehicle lift and battery removal and replacement means. The platform is for instance carried by a truck or towed on a trailer as in FIG. 1M. A ramp attached to the platform, truck, or trailer allows an electric (or hybrid) vehicle to drive (or be towed, winched, pushed, or otherwise moved) onto the flat platform. The vehicle lift, which may be for instance a four pillar lift, raises the vehicle up to a height of ˜1 meter off the platform, allowing access to the underside of the vehicle. A battery receiving unit is provided that travels along the platform on rails, moving under the vehicle until it reaches a point directly underneath the battery bay of the vehicle. This unit may travel for instance on rails, and be propelled e.g. by a rack and pinion, screw, chain, cable, or other means as will be obvious to one skilled in the art. This receiving unit is then lifted up towards the bottom of the suspended vehicle by a battery lift (which may be a scissor lift for instance), until such point as the receiving unit engages the battery. The battery is then disengaged from the vehicle and now rests on the receiving unit. The battery lift now lowers the receiving unit, which then moves out from under the vehicle battery bay. A replacement unit is provided that carries a charged battery, and which now moves into place under the vehicle battery bay, again travelling along the rails by means of screw, cable, or other suitable device. The battery lift then inserts the replacement battery into the vehicle. The vehicle then engages the battery, the receiving and replacement units travel out from under the vehicle, the vehicle is lowered from its lift, and the vehicle may now be driven or otherwise moved down the off the platform and down the ramp.

The following paragraphs make reference to FIGS. 1A-L which depicts an embodiment of the current invention in isometric views.

A portable changing platform 1000 (carried on a trailer, truck, or the like, or placed at an arbitrary location) is provided that allows removal and replacement of an electric vehicle battery of ˜250 kg 1001 (FIG. 1A). A ramp attached to the trailer, truck, or platform allows the car to be either towed, winched, driven, or otherwise moved onto the changing platform. The changing platform is provided with a four pillar lift 1002 that raises the car up to ˜1 meter above the ground (FIG. 1B), allowing access to the underside of the car 1003. Obviously other lifting means can be used as will be obvious to one skilled in the art. A battery lift, which may for instance be a scissor lift 1008 (FIG. 1D) is provided that travels on rails 1005 on the platform until it is located directly under the battery bay of the vehicle. Alternatively, the battery lift may be fixed in position, and the pillar lift 1002 may move along rails to position the vehicle such that its battery bay is directly over the battery lift 1008. A receiving unit 1004 (FIG. 1B, C) is provided that also travels on rails 1005 spanning the length of the changing platform 1000. These rails 1005 may optionally be the same rails as those used by the battery lift 1008. This receiving unit is provided with a tray or other means adapted to hold an electric vehicle battery. The receiving unit 1004 (FIG. 1D) travels under the vehicle until it is positioned directly under the electric vehicle's battery bay, and directly over the battery lift 1008. The receiving unit 1004 is then lifted by the battery lift 1008 until it comes into mechanical contact with the depleted battery 1001. Once the receiving unit 1004 is in contact with the depleted battery, the electric vehicle disengages the battery, which now rests upon the receiving unit 1004. This procedure (of positioning, disengagement, and the further operations to be described below) may be performed entirely automatically by use of optical, mechanical, electromechanical, or other means as will be obvious to one skilled in the art. For example, each make of electric vehicle has a known offset between front wheels and battery bay. The receiving unit and battery lift may thus be propelled forward from their starting positions by a screw, pinion gear, or other means, by the required distance to position them directly under the battery bay. The steps of the procedure may thus be controlled by microprocessor or other computing means, in some embodiments providing access to a database of electric vehicle parameters. It should be clear that the battery receiving unit and battery lift may move together to save time. In some embodiments the receiving unit is provided with its own integral battery lift, while in other embodiments a single lift is shared by receiving and replacement units.

Once the depleted battery 1001 is disengaged from the vehicle and rests on the receiving unit 1004, the battery lift 1008 lowers the receiving unit back onto the rails 1005. The receiving unit 1004 now travels to make room for the battery replacement unit 1006 (FIGS. 1C, H) to move into place under the battery bay. In one embodiment, the receiving unit 1004 travels towards the rear of the vehicle as shown in the figures, while in other embodiments it travels towards the front of the vehicle, e.g. if the vehicle is backed onto the platform in the direction opposite that shown in the figure. The replacement unit 1006 (FIG. 1C, H) may be similar to the receiving unit 1004, having a tray or other means adapted to hold a fresh electric vehicle battery 1009 (FIGS. 1D, E, F). The receiving unit 1004 and replacement unit 1006 may also be physically attached or otherwise linked, and the replacement unit 1006 in some embodiments travels on the same rails 1005 as the receiving unit 1004.

The replacement unit 1006 now travels along the rails until it is directly under the battery bay and over the battery lift 1008 (FIG. 1F). The replacement unit 1006 is then lifted by the battery lift 1008, and inserts the fresh battery 1009 into the battery bay of the electric vehicle (FIG. 1G, H). The battery is now engaged by whatever grasping or engagement means the electric vehicle is provided with. Once the fresh battery has been loaded into the vehicle, the receiving and replacement units 1004,1006 travel back along the rails, (FIG. 1I), and the electric vehicle may now be lowered down to the changing platform surface (FIG. 1J) and driven off the platform and down the ramp. The depleted battery 1001 is meanwhile transferred into the depleted battery storage magazine 1012 (FIG. 1K) and a fresh battery 1010 is loaded into the replacement unit (FIG. 1L) from the fresh battery storage magazine 1007. The system is now ready for the next electric vehicle to have its battery replaced.

A typical sequence of operations for battery replacement would run as follows:
a. The device of the current invention is carried or towed on a truck, trailer, or by other means transported to a location where electric vehicle(s) needing battery replacement are located or are expected to be located.
b. The BEV is moved onto the platform. In one embodiment of the invention, the BEV's tires are engaged in tire-grasping lift devices provided for this purpose.
c. The vehicle is lifted up by a four pillar lift, to a height higher than the battery height.
d. The receiving and replacement units move along the rails until the receiving unit is positioned just below the vehicle battery bay.
e. The battery lift 1008 is raised, until the top of the battery lift platform contacts the battery. The car releases the depleted battery onto the battery lift. Alternatively, the receiving unit is raised by the battery lift, and the battery is released onto the receiving unit which rests upon the battery lift.
f. The battery lift with depleted battery upon it is lowered down placing the battery in the receiving unit, and the receiving unit moves out from under the battery bay.
g. The replacement unit (holding a fresh battery) is positioned underneath the now empty battery bay.
h. The scissor lift lifts the battery into the electric vehicle. The electric vehicle locks down the fresh battery in the battery bay.
i. The scissor lift is lowered.
j. The receiving and replacement units move along the rails towards the front of the BEU (which is that end near the battery magazine 1007 of FIG. 1I, J)
k. The car is lowered down to the surface of the platform, by the four pillar lift.
l. The car is driven, winched, or otherwise moved off the platform and down the ramp.
m. The receiving unit discards the depleted battery it bears into a used battery magazine/storage device.
n. The replacement unit is loaded with a fresh battery from the fresh battery storage device.

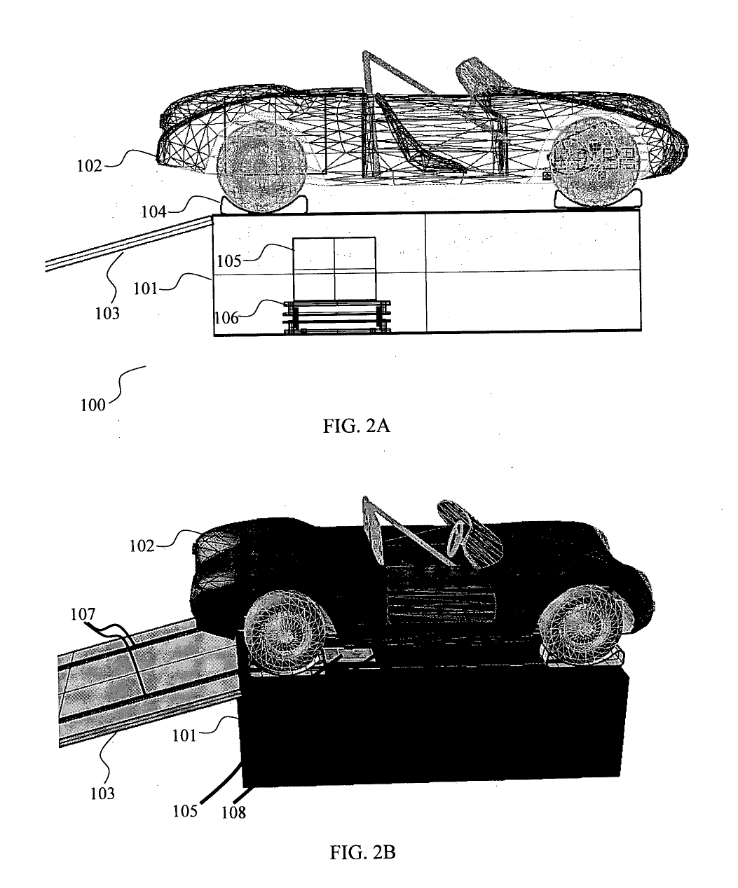

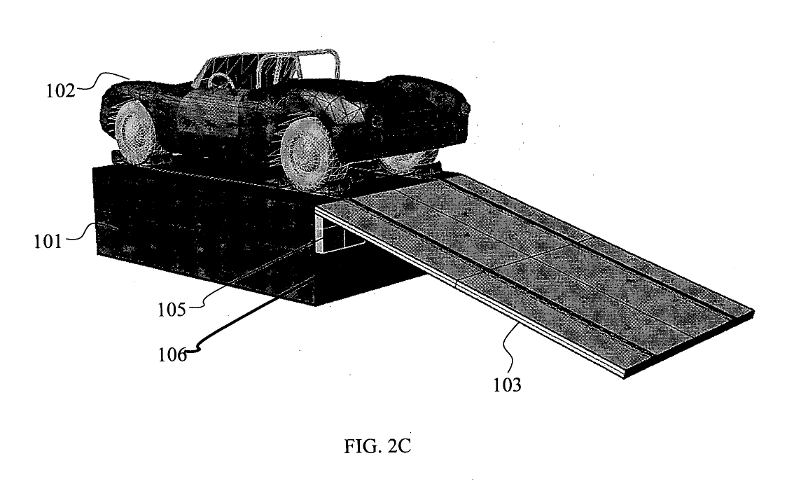

The following paragraphs make reference to FIGS. 2A, B, C which depict another embodiment of the current invention in side and isometric views. A portable device 100 is provided that allows removal and replacement of an electric car battery of ˜200 kg. The device consists of a hollow box 101 upon which a BEV 102 may rest. A ramp 103 is provided on the side of the box to allow the car to drive or be towed (for instance by tire-grasping devices 104 that are towed on slide 107 (FIG. 2B), by chain-drive, by cable, or by other means as will be obvious to one skilled in the art) onto the box 101. In one embodiment the system is adapted for the case when the battery 105 of the BEV is carried and accessed from underneath the car. In this embodiment an opening is provided on the top face of the box (108 in FIG. 2B, opening not visible from side view), allowing access to the underside of the car from within the box. A receiving unit 106 is provided within the box that is adapted for removing the battery from the undercarriage of the car. A replacement unit is also provided, adapted for putting a new battery in place of the old into the car. The receiving and replacement units may conceivably be combined in a single unit as is the case in FIG. 2. A possible embodiment of a combined battery receiving/replacement unit is shown in FIGS. 2A-C. The battery receiving/replacement unit 106 has an upper platform on which a battery may rest stably. The unit also is provided with facility for change of height, in this example by means of a scissor lift. The unit may be provided with wheels to allow it to move from place to place, or it may move on rails or other means as will be obvious to one skilled in the art.

A typical sequence of operations for battery replacement would run as follows:
a. The BEV tires are engaged in the tire-grasping devices 104.
b. The vehicle is pulled up the ramp 103 by means of chains in the slide 107 that pull the tire-grasping devices 104, such that the vehicle battery bay is just above the opening on the top of the BEU.
c. The receiving/replacement unit 106 is positioned just below the opening 108 on the top of the BEU (and therefore just below the vehicle battery bay).
d. The scissor lift of the receiving unit is activated until the receiving unit platform contacts the battery.
e. The battery attachment means attaching the battery to the BEV are retracted/released.
f. The scissor lift, with battery upon it, is lowered.
g. The receiving/replacement unit 106, bearing the spent battery, moves along its track towards the front of the BEU. (The front being e.g. that end near battery magazine 1007 of FIG. 1 I, J).
h. The receiving/replacement unit 106 discards the battery it bears into a used battery magazine.
i. The receiving/replacement unit travels towards a fresh battery magazine (e.g. at the back end of the box 101) from which it receives a fresh battery.
j. The receiving/replacement unit, with fresh battery upon it, moves along the bottom of the box 101 until it is positioned just below the battery bay of the vehicle.
k. The scissor lift of the receiving/replacement unit rises until the battery is positioned within the battery bay of the vehicle.
l. The battery attachment means of the electric vehicle are activated.
m. The receiving/replacement unit travels upon its track towards the back of the BEU.
n. The BEV travels down the ramp 103, borne by the tire-grasping devices 104.

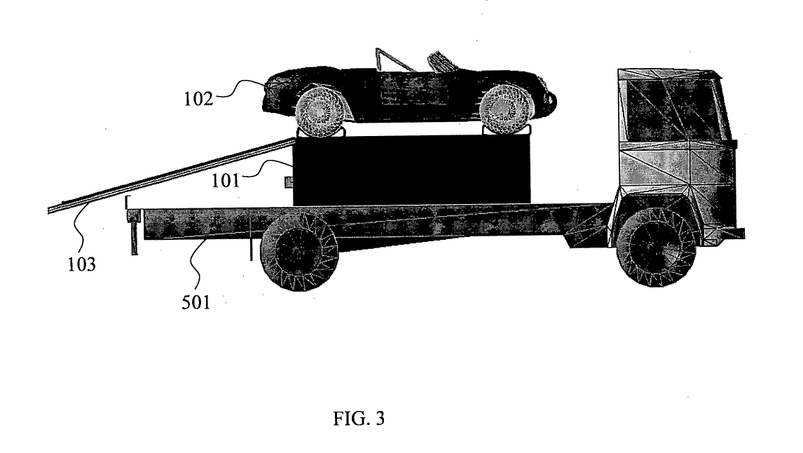

Obviously for the BEV to be serviced by the device, the device must be located in proximity to the BEV which may be stranded far from service stations. Therefore in a preferred embodiment of the invention, the device of the present invention is adapted to be transported on the bed of a standard truck such as a tow truck, flatbed truck, delivery truck or the like. An example is shown in FIG. 3, where the flatbed truck 501 carries the box 101 of the BEU on its bed. In this embodiment the ramp 103 is preferably retractable such that it may be stored e.g. on the top of the box 101 during travel, and deployed in the field as necessary.

In one embodiment of the device, the device described can be mounted on top of a service truck or can be used as a stand alone device with an extra downhill ramp. The combination of battery exchange unit and service truck serves as an integrated solution to the need for field service of stranded BEVs. The service truck may be used to rescue stranded cars. Additionally, the truck may be stationed in remote areas as a standalone battery replacement solution.

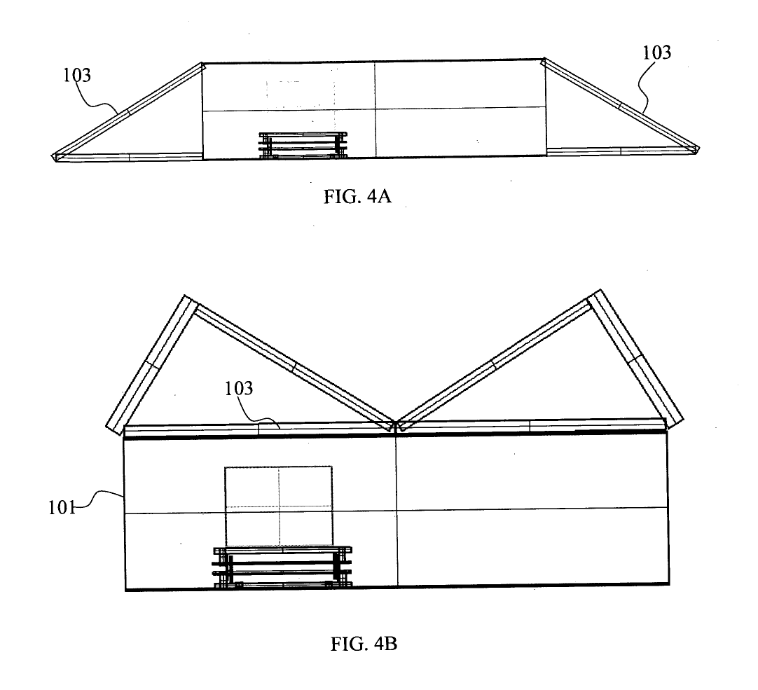

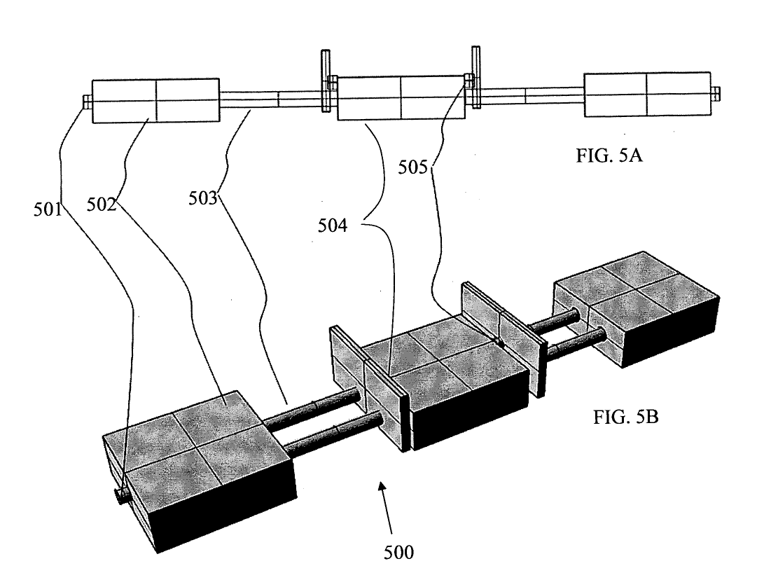

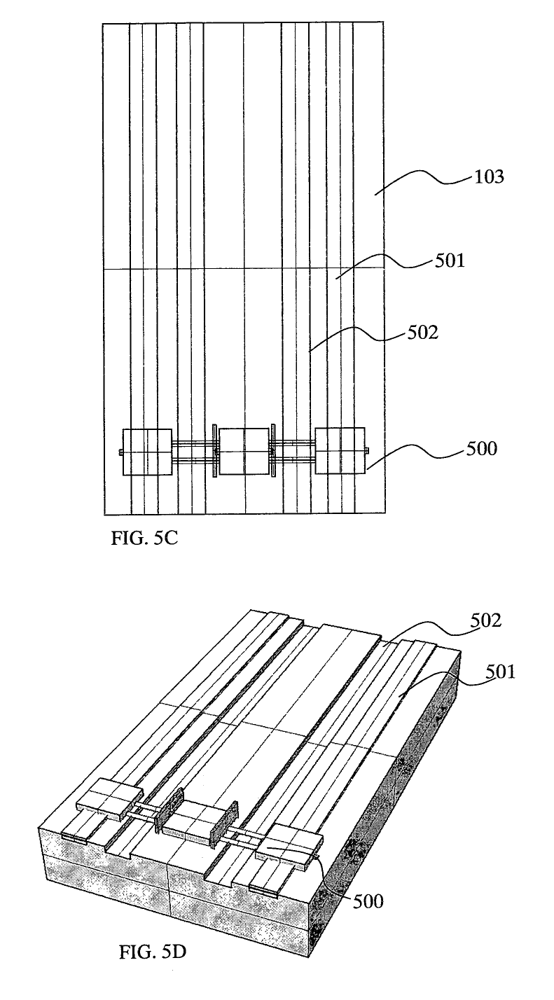

One embodiment using an extra downhill ramp is shown in FIGS. 4A, B where the ramps 103 can be folded onto the box 101. FIG. 4A shows the ramps in their deployed configuration while FIG. 4B shows the ramps in their folded configuration. One possible embodiment of the tire grasping device 500 is shown in FIGS. 5A, B.

Here one sees engagement cylinders 503 in which the tire of the vehicle rests. The cylinders rest in tracks in blocks 502 such that their height may be varied independently. This serves two purposes: the cylinders may be lowered to allow a car to easily pass between them, and raised to lift the car off the ground. Then one cylinder can be raised more than the other to more securely engage the vehicle when on an incline such as the ramp 103. The screw 501 engages one or more of the cylinders 503 in order to cause this movement. The planes 504 are pushed by hydraulic or pneumatic cylinder 505 in order to center the vehicle on the device to facilitate the battery exchange operation, which in general will require a precise alignment between vehicle and battery replacement mechanisms.

This device is shown in place on the ramp 103 in FIGS. 5C, D. The tire-grasping device 500 slides along track 501, pulled by a chain drive (not visible). In the case that the ramp folds onto the top of the box as in FIG. 4, the chain drive must have the freedom to fold. Depressions 502 allow the tire to avoid contact with the box surface.

In another embodiment of the device, the BEU is deployed in a stationary manner, to serve as a minimal battery exchange station. In this embodiment the device is simply placed at a given location, e.g. an unused area at a regular gas station, and the ramp extended. Electric vehicles needing battery replacement use the device to replace their battery and are charged for the service by suitable means as will be obvious to one skilled in the art. This embodiment may find ready adoption, for instance, in sparsely populated areas with large distances between population centers. By placing BEUs at suitable locations, for instance at rest areas or along the sides of highways, the range of electric vehicles can be drastically increased. In those embodiments such as those described in this paragraph, the BEU can be placed in a pit of depth equal to the box's height, such that no ramp is needed and the EV may be driven or pulled directly onto the box.

In one embodiment of the invention, the BEU is provided with an EV charging cable capable of quickly charging a car just enough for it to drive a few meters onto the tire engagement device of the BEU. Alternatively, the car remains connected to this EV charging cable while driving onto the tire engagement device. This would be useful for instance in the case that the battery of the EV has malfunctioned and cannot be charged. In a preferred embodiment of the invention the BEU has provision for carrying out a financial transaction to allow the owner of the BEU to take some form of payment from EV owners replacing their batteries. The batteries may, for instance, be leased, rented, or owned by the driver, and payment may be at the place of the BEU by cash, credit, or the driver may be billed automatically by other means.

In a preferred embodiment of the present invention, the BEU device is provided with two battery magazines, a spent battery magazine and a charged battery magazine. In a preferred embodiment, the BEU is provided with means to load fully charged batteries into the charged battery magazine and release spent batteries from the spent battery magazine. Alternatively, the magazines in their entirety are replaceable; this would allow the device to exchange a spent battery magazine full of spent batteries with an empty spent battery magazine, and to exchange an empty charged battery magazine with a charged battery magazine full of charged batteries.

In one embodiment of the device there is provided a mechanism to insert batteries into the device and remove spent batteries from the device. This mechanism can either comprise a part of the BEU or may be installed on a service truck adapted for replacing the batteries of the BEU.

In one embodiment of the invention, a small and simple mobile device is provided that is able to exchange batteries from electrical cars, for use (for example) by garages and car maintenance shops. This device should be minimal in size—no ramp or trolleys just a basic capability to demount a 250 Kg battery and mount one back in.

In one embodiment of the invention, the BEU is electrically operated, including operations of pulling the EV onto the BEU, removing the spent battery, and installing a charged battery. In this case the device itself may have one or more batteries, which we refer to as the BEU operation batteries, to operate it. This BEU operation battery may for instance simply be one of the charged batteries in the charged battery magazine.

In a preferred embodiment the device will be able to connect to an electrical charging point, so that the BEU operation battery, as well as the batteries in the spent magazine, can all be charged.

In one embodiment of the invention there is provided a second ramp disposed on the side of the box opposite the first ramp, allowing cars to travel off the box (after battery replacement) in the same direction of motion as they arrived on the box.

In the preferred embodiment the device is of minimal height. To this end the battery receiving and replacement units are of minimal height, employing the pneumatic arms lifting the batteries from the side, a scissor mechanism as shown in FIG. 2 or the like as will be obvious to one skilled in the art.

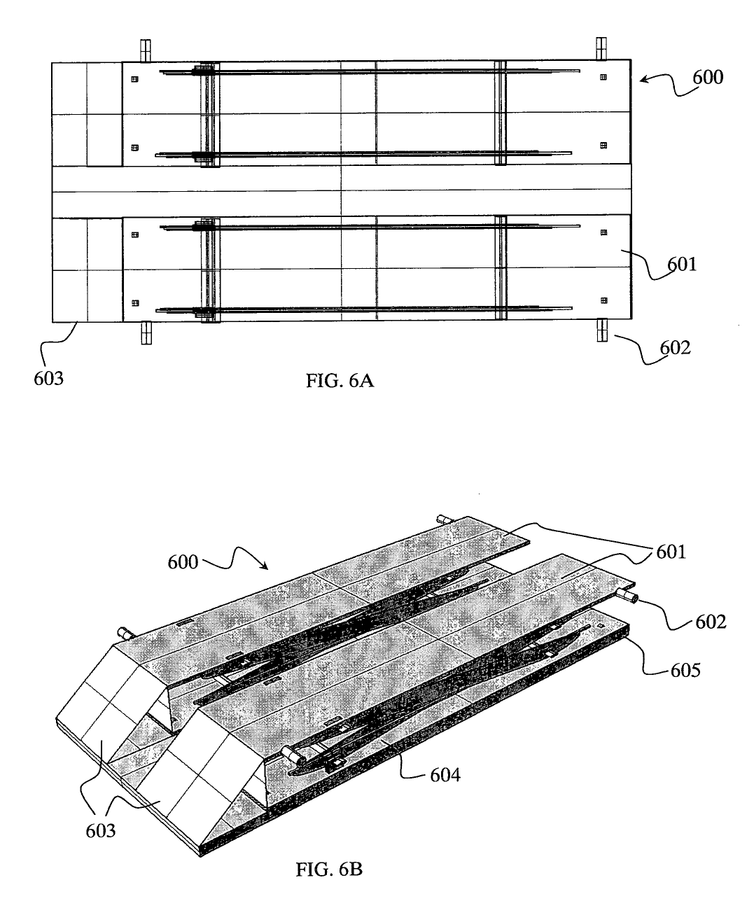

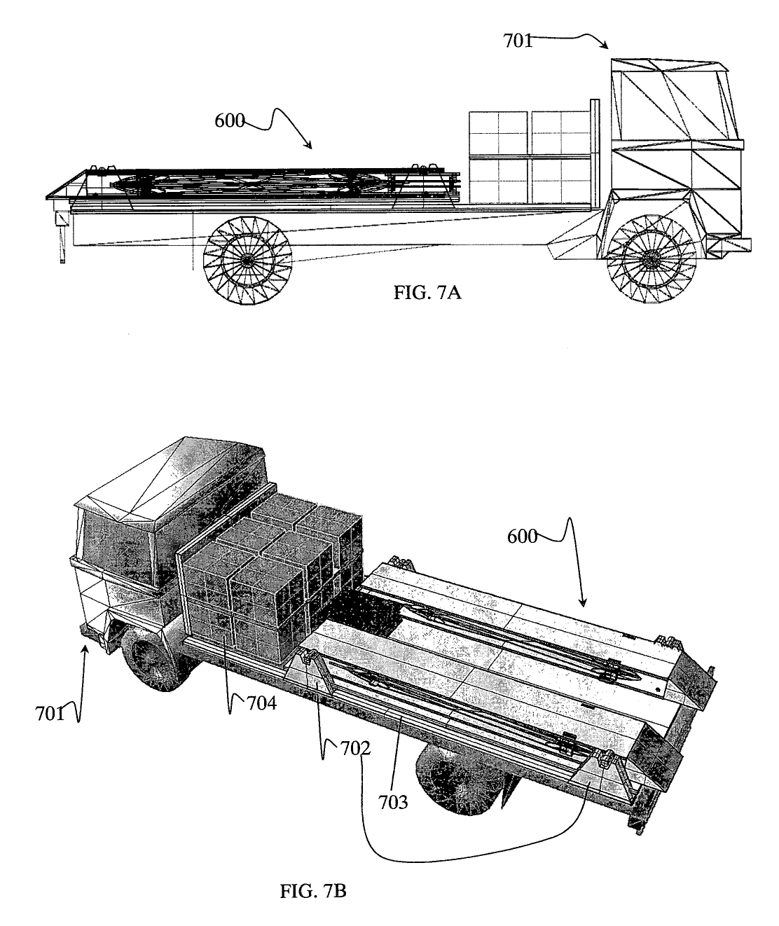

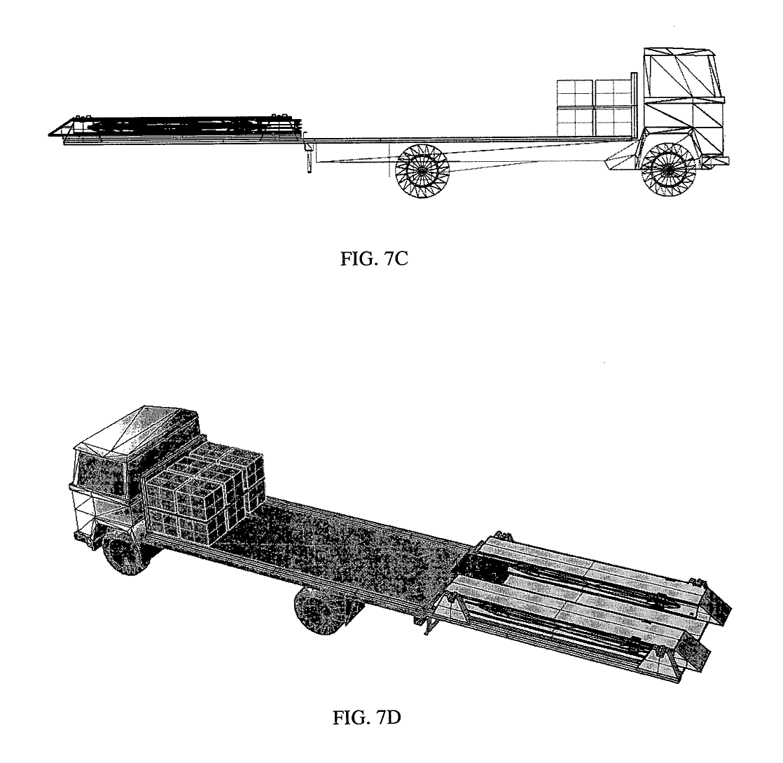

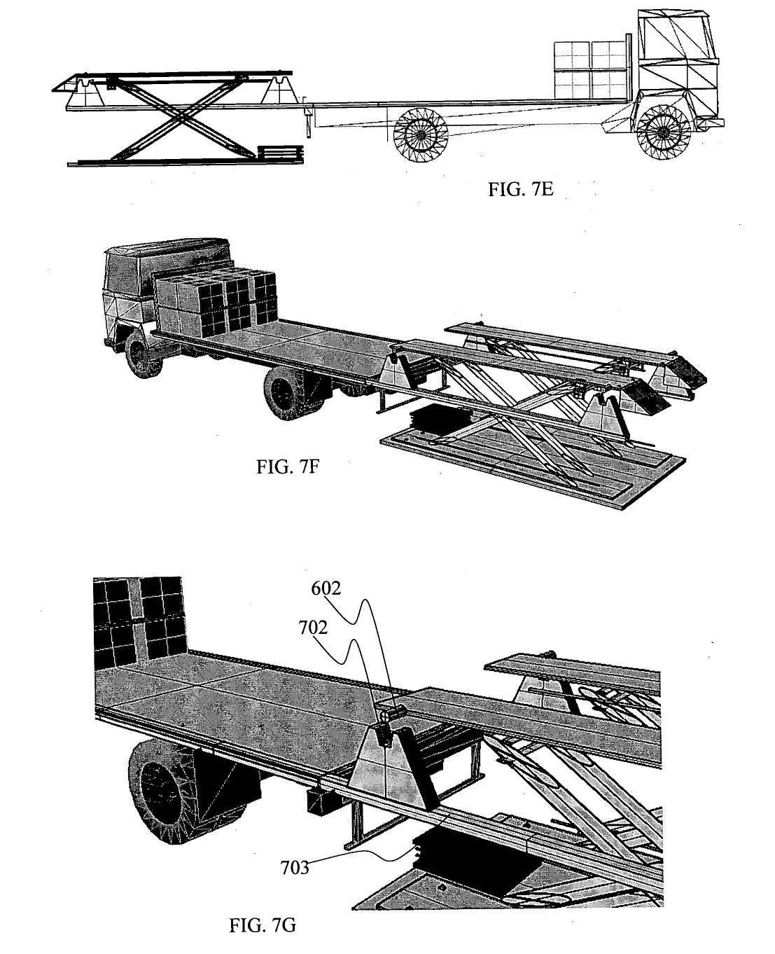

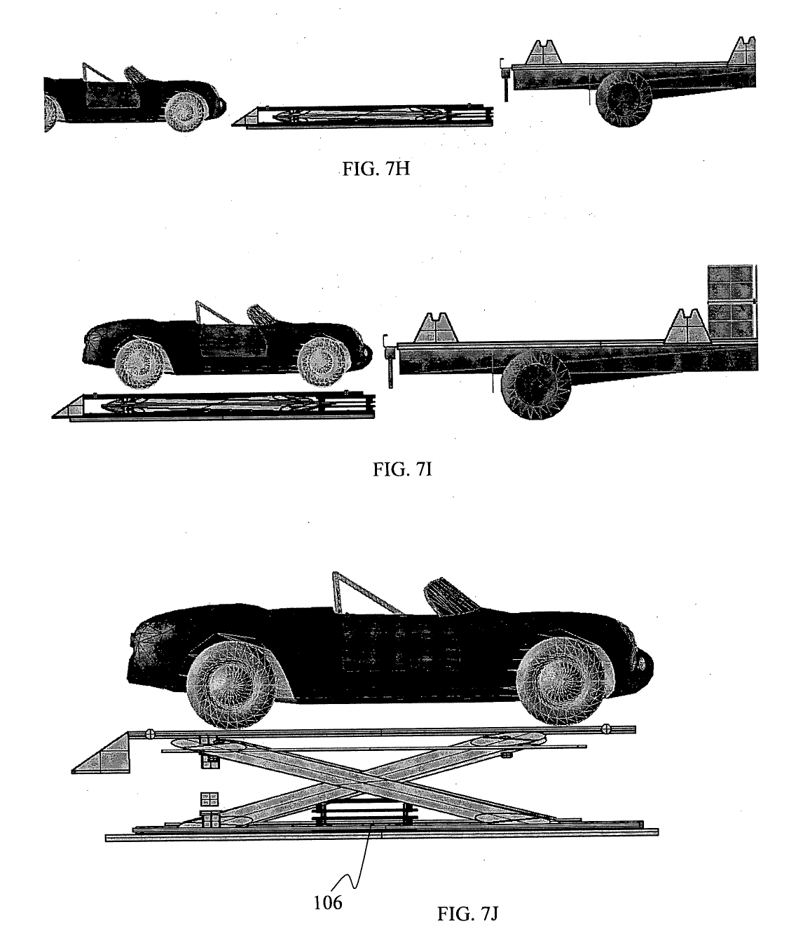

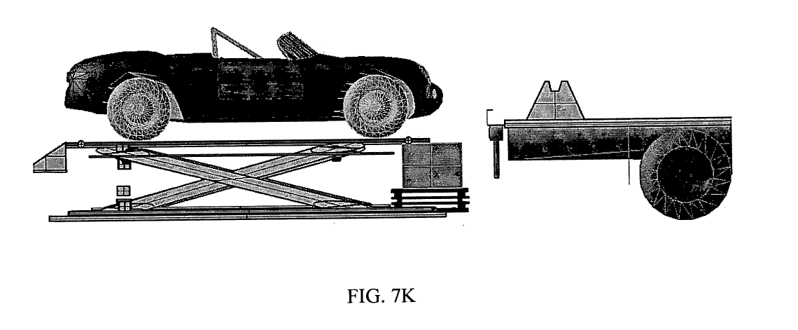

In one embodiment of the device, a delivery vehicle such as a truck carries an exchange unit such as that shown in FIGS. 6A, B. Here the exchange unit 600 consists of two parallel lifting devices such as scissor lifts 604, which are adapted to lift the platforms 601 upon which a car may rest. The device is provided with ramps 603 which in some embodiments may be folded upon the platforms 601 for more compact storage. The two lift mechanisms are fixed to lower platform 605. This exchange unit is lowered from the truck to the ground by suitable means as will be obvious to one skilled in the art. The truck will preferably carry a magazine of batteries 704 upon it. A particularly suitable means, which may not be obvious, is now described and illustrated in FIGS. 6 and 7. The BEU 600 is held in place on the delivery truck 701 by means of rods 602 attached to the top platforms 601. These rods are held by holding members 702 which are fixed on rails 703 to the truck 701. The holding members 702 slide off the truck on rails 703 by means of linear bearings, as in a drawer mechanism until reaching a state such as that shown in FIGS. 7C, D. At this point the lift mechanism 604 is extended. Since the BEU is held fixed at the top platforms 701, the bottom of the lift will lower. This action is continued until several inches after the lower platform 605 reaches the ground, causing the BEU to be lifted off of the holding members 702 (see FIGS. 7E, F, G). At this point the rails 703 are withdrawn back onto the truck. Now the lift mechanism may be retracted, lowering the top platforms 601 as shown in FIG. 7H. The BEV that requires a battery change may now be driven or towed onto the BEU as in FIG. 7H. In one embodiment of the invention, electric power cables suitable to provide temporary traction power to the BEV are included in the apparatus of the BEU. Once upon the BEU, the vehicle is lifted by means of extension of the lift apparatus 604 shown in FIG. 7J. At this point the battery exchange receiving/replacement unit 106 moves into position underneath the car. In certain embodiments of the invention, this battery receiving/replacement unit is provided with its own lifting apparatus (such as a scissor lift), but this is not necessary in other embodiments, wherein the lifting mechanism 604 is sufficient for all lifting operations. In particular, once the battery receiving/replacement unit 106 is in place underneath the depleted vehicle battery, the lifting mechanism 604 is retracted slightly until the battery is in contact with the top surface of the receiving/replacement unit. Then the battery attachment means (that attach the battery to the BEV) are deactivated/retracted, leaving the battery resting freely upon the surface of the BRRU. The car is then lifted slightly by lift apparatus 604, allowing the BRRU to exit towards the edge of the BRU as in FIG. 7K.

At this point the empty battery is swapped with a charged battery. In one embodiment of the invention the charged battery is pre-loaded onto the BRU and thus can be swapped with the depleted battery onto the BRRU at ground level. In another embodiment of the invention, the charged battery is conducted from the battery magazine 704 onto the BRRU while the depleted battery is conducted away from it and returned to the battery magazine 704, by means that will be clear to one skilled in the art, such as a chain drive on the truck and a lift mechanism in the BRRU.

Now the operation of battery replacement can commence. The charged battery now available on the BRRU is conducted into place by appropriate translation of the BRRU under the now empty battery box of the BEV. Then the battery is positioned into the battery box either by lowering of the car platform 601 or raising of the BRRU lift mechanism, or both. Once the battery is in place, the battery attachment means are activated and the BRRU withdrawn, again either by lower the BRRU or by raising the platform 601 or both.

The final operations consist largely of reversing the preceding sequence. Namely, the platform 601 is lowered, and the car driven or otherwise conducted off of the platform. Then the platform is raised to a point above the vertical level of the holding members 703. The rails 702 and holding members 703 upon them are extended to underneath the bars 602. Then the platform extension/retraction means 604 is retracted, causing the bottom of the BEU 605 to rise. Once the unit is fully retracted, the rails 702 are retracted, pulling the BEU 600 onto the bed of the truck 701. If necessary a fresh battery may now be preloaded onto the BEU 600, or one or more batteries thereon may be charged by a power source on the truck 701.

In this way the present invention provides a means to place a BEU on the side of the road using a lift or other hydraulic or pneumatic mechanism. It will be clear to one skilled in the art that the battery operated BEU autonomously work as an autonomous mini battery replacement station, unfolding up and down ramps, by the simple addition of a battery magazine in communication with the BEU. It is envisioned that such minimal battery replacement stations will greatly facilitate the launch of a battery electric vehicles, whose primary drawback at present is a limited range. With provision for rapid battery replacement this drawback is ameliorated. The present invention provides a cheap and effective solution for rapid battery replacement by means of the easily transportable BEU.

A further provision of the current invention includes multiple charge points on the BEU truck. In this embodiment the truck may charge vehicles by cable, instead of exchanging batteries. The truck will be able to connect to the electrical power grid in many fashions and at multiple points and in some embodiments is supplied with an independent power supply such as a generator, fuel cell, large capacitance, or large battery. These trucks can be used as a temporary solution in uncovered spots of the grid or on special occasions such as rock concerts in a park and the like, or in places it is not possible yet to deploy a stationary charge spot.

In some embodiments of the current invention the device of the current invention provides a magazine for depleted batteries and a separate magazine for fresh ones. In another embodiment, a single magazine is employed that cycles batteries in a fashion similar to an airport luggage carousel. In a preferred embodiment, the batteries are charged inside the magazine, either while the magazine is connected to the electricity grid or to another source of electrical power. In those embodiments wherein a single carousel magazine is used, the device is provided with logic such that charged batteries are swapped for depleted batteries when swapping batteries with a BEV and depleted batteries are swapped with charged batteries when swapping batteries with a source of charged batteries such as a fully provisioned stationary battery exchange station.

Obviously for the BEV to be serviced by the device, the device must be located in proximity to the BEV which may be stranded far from service stations. Therefore in a preferred embodiment of the invention, the device of the present invention is adapted to be transported on a trailer or the bed of a standard truck such as a tow truck, flatbed truck, delivery truck or the like.

Additionally, the device, can be used as a standalone battery replacement solution with a uphill and downhill ramps (or buried in a proprietary pit), stationed in remote areas. It is anticipated that as in many technologies, there will be a distinct lack of standardization of battery format in the early years of electric vehicle mass production. Thus it should be particularly appreciated that any format or size of battery can be dealt with by the system disclosed without need for modification of the changing platform or rails; only the scissor lifts and in some cases only the tops of the scissor lifts need be changed in order to facilitate new types or formats of batteries. In other cases only the size and/or shape of the battery receiving unit and/or battery replacement unit need be changed to accommodate new battery formats, sizes, or shapes.

It is within provision of the invention that the changing platform be deployed alone, that it be carries on a truck or trailer, or that it be provided with wheels and motive power such that it serves itself as a vehicle.

It is within provision of the invention that the operations of the device be controlled by a microcontroller or other computing or control means.

It is within provision of the invention that these computing or control means be in electrical communication with sensing means such as optical sensors, mechanical sensors, electrical sensors, and others as will be obvious to one skilled in the art.

It is within provision of the invention that the computing or control means be in electrical communication with actuating means such as electrical motors, actuators, electromagnets, field generators, screws, racks, pinions, gearwheels, chain drives, and the like as will be obvious to one skilled in the art.

By means of the sensing and actuating means, the control means of the device can accurately synchronize the operations of the various parts of the invention.

It is within provision of the device that the computing means be in communication with a database (either locally or remotely) that is provided with relevant information concerning the geometric and/or electrical specifications of a plurality of electrical vehicles.

It is further within provision of the invention that the computing means be provided with identification means adapted to identify the make and model of the electric vehicle being serviced.

1-28. (canceled)

29. A portable battery replacement device adapted for exchanging depleted batteries with charged batteries in an electric vehicle, comprising:
a. a platform (1000) adapted to hold said electric vehicle upon it;
b. a vehicle lift (1002) adapted to raise said electric vehicle off said platform to allow access to said battery of said electric vehicle;
c. a battery lift (1008) adapted to lower and raise electric batteries into and out of said electric vehicle;
d. a battery receiving unit (1004), adapted to receive the depleted battery (1001) from said electric vehicle;
e. a battery replacement unit (1006) adapted to place a charged battery (1009) into said electric vehicle;
f. a battery magazine (1007) adapted to hold electric vehicle batteries;
g. rails (1005) upon said platform adapted to allow travel of said depleted-battery receiving unit (1004) and said battery replacement unit (1006) between said magazine and said electric vehicle;
h. sense and control means adapted to control the sequence of battery replacement operations; wherein said device allows battery exchange by use of an automated portable device.

30. The method of claim 38, further provided with a depleted-battery magazine adapted to store and accept depleted batteries from said depleted-battery receiving unit, and a charged-battery magazine adapted to store and transfer charged batteries to said charged-battery replacement unit.

31. The portable battery replacement device of claim 29, further provided with manipulation means adapted to allow said portable battery replacement device to be removed from and replaced onto a vehicle adapted to transport said device.

32. The portable battery replacement device of claim 29, wherein said batteries in said magazine may be shifted in cyclic fashion to allow access to each battery in turn.

33. The portable battery replacement device of claim 29 adapted to act as a stand alone device that may be placed in arbitrary locations, providing a battery replacement service to electric vehicles in need of battery replacement.

34. The portable battery replacement device of claim 29 further providing a vehicle adapted to transport said portable battery replacement device, a ramp adapted to allow said electric vehicle to drive onto said platform, and transport means adapted to pull said vehicle up said ramp.

35. The portable battery replacement device of claim 34 wherein said transport means are chosen from a group consisting of: tire-grasping devices, cable tow, chain drive, conveyer belt, electric vehicle power, and combinations thereof.

36. The portable battery replacement device of claim 29 wherein all functional elements are electrically powered.

37. The portable battery replacement device of claim 29, further providing an electric power inlet adapted for receiving electric power from an external source, charging depleted batteries with said electric power, and providing electric power to one or more electric vehicles.

38. A method for exchanging the battery of an electric vehicle comprising steps of:
a. providing a platform adapted to hold said electric vehicle upon it;
b. providing a vehicle lift adapted to lift said electric vehicle to allow access to the battery of said electric vehicle;
c. providing a ramp and transport means adapted to allow said electric vehicle to be transported from the ground onto said platform;
d. providing a depleted-battery receiving unit, adapted to remove the depleted battery from said electric vehicle;
e. providing a charged-battery replacement unit, adapted to place a charged battery in said electric vehicle;
f. disposing said platform in the vicinity of said electric vehicle;
g. transporting said electric vehicle up said ramp onto said platform by use of said transport means;
h. raising said electric vehicle off the surface of said platform by means of said vehicle lift;
i. removing said electric vehicle battery by means of said depleted-battery unit;
j. replacing said electric vehicle battery by means of said charged-battery replacement unit;
k. lowering said electric vehicle onto the surface of said platform;
l. transporting said electric vehicle down said ramp and off of said platform by use of said transport means;
m. wherein batteries of electric vehicles are replaced by use of an automated portable device that may be transported and deployed in the field.

39. The method of claim 38, wherein said vehicle lift, said depleted battery receiving unit and said charged-battery replacement unit are provided with lift means selected from a group consisting of: pillar lift, scissor lift, hydraulic lift, pneumatic lift, escalator, fork lift, suspension lift.

40. The method of claim 38, further provided with a depleted-battery magazine adapted to store and accept depleted batteries from said depleted-battery receiving unit, and a charged-battery magazine adapted to store and transfer charged batteries to said charged-battery replacement unit.

41. The method of claim 38, further providing manipulation means adapted to allow said portable battery replacement device to be removed from and replaced onto a vehicle adapted to transport said device.

42. The method of claim 38, wherein said platform is characterized by a surface area larger than the average vertically projected electric vehicle area.

43. The method of claim 38, adapted to act as a stand alone device that may be placed at arbitrary locations, providing a battery replacement service to electric vehicles in need of battery replacement.

44. The method of claim 38, wherein said transport means are chosen from a group consisting of: tire-grasping devices, cable tow, chain drive, and electric vehicle power.

45. The method of claim 38, wherein all operations thereof are electrically powered by electric batteries.

46. The method of claim 38, further providing an electric power inlet adapted for receiving electric power from an external source, charging depleted batteries with said electric power, and providing electric power to an electric vehicle.

47. The method of claim 38, further providing transaction means for payment for and logging of battery replacement services rendered.

48. A method of hand-operated electric vehicle battery replacement consisting of:
a. providing a mobile device adapted for exchanging electric vehicle batteries of minimal size, provided with a platform adapted for holding said batteries, and lifting means adapted for lifting said batteries;
b. removing depleted batteries from said electric vehicles by means of said mobile device;
c. inserting charged batteries into said electric vehicles by means of said mobile device.
